(19) United States
(12) Patent Application Publication
(10) Pub. No.: US 2023/0053120 A1
(43) Pub. Date: Feb. 16, 2023

(54) OPTICAL DEVICES WITH PHOTOCHROMIC MATERIALS AND ELECTRICALLY DIMMABLE ELEMENTS FOR AUGMENTED REALITY APPLICATIONS

(71) Applicant: Meta Platforms Technologies, LLC, Menlo Park, CA (US)

(72) Inventors: Afsoon JAMALI, Issaquah, WA (US); Jasmine Soria SEARS, Kirkland, WA (US); Sho NAKAHARA, Bothell, WA (US); Kurt JENKINS, Sammamish, WA (US); Abbas Mehdi KAZMI, Woodinville, WA (US); Sandro PINTZ, Menlo Park, CA (US); Arman BOROMAND, Issaquah, WA (US)

(21) Appl. No.: 17/885,454

(22) Filed: Aug. 10, 2022

Related U.S. Application Data
(60) Provisional application No. 63/232,479, filed on Aug. 12, 2021.

(51) Int. Cl. G02F 1/157; G02B 27/01

(52) U.S. Cl. CPC G02F 1/157; G02B 27/0172; G02B 2027/0178

(57) ABSTRACT

A headset for augmented reality applications is provided. The headset includes at least one eyepiece configured to provide a see-through image to a user via a transparent optical component, and to provide an artificial image through a display, and a dimming shutter configured to adjust a transparency level of the transparent optical component. The dimming shutter further includes an active liquid crystal layer configured to adjust a transparency level according to an electrical power provided between two electrodes, and a photoactive layer configured to adjust the transparency level upon absorption of an ultraviolet radiation for a selected period of time. A default orientation of a host material in the active liquid crystal layer may be in a dark state or in a clear state, when no electrical power is provided. A method and a memory storing instructions to execute the method for use of the above device are also provided.

### RELATED APPLICATIONS

This application claims priority to U.S. Provisional Application Ser. No. 63/232,479, filed on Aug. 12, 2021, which is incorporated by reference herein in its entirety. This application is related to U.S. Provisional Application Ser. No. 63/233,136, filed on Aug. 13, 2021 and U.S. Provisional Application Ser. No. 63/248,932, filed on Sep. 27, 2021, both of which are incorporated by reference herein in their entireties.

### TECHNICAL FIELD

This relates generally to optical devices with dimming capabilities, and more specifically to optical devices with photochromic materials and electrically dimmable elements for smart glasses and other augmented reality (AR) applications.

### BACKGROUND

Electrical dimming devices available to adjust the transparency level of an eyepiece or lens may consume too much power, and/or offer a low dynamic range of transparency, normally with low transmission in the clear state and low opacity in the dark state. Photochromic dimming devices that utilize photochromic materials may offer a wider dynamic range with a high transmission in the clear state and high opacity in the dark state, but the response of these materials typically requires ultraviolet light for transition and is temperature dependent, which limits their applications. For example, photochromic dimming devices may not be able to switch from the clear state to the dark state indoors where the intensity of ultraviolet light is often insufficient to switch the photochromic dimming devices into the dark state.

### SUMMARY

Accordingly, there is a need for dimming devices that can operate both indoors and outdoors, be fast, offer a wide dynamic range of transparency, and are power efficient, in particular for augmented reality applications. The devices and methods disclosed herein enable such dimming devices.

In accordance with some embodiments, an optical device includes a first dimmable element including a layer of one or more photochromic materials; and a second dimmable element optically coupled with the first dimmable element to receive light transmitted through the first dimmable element.

In accordance with some embodiments, a head-mounted display includes an optical device with a first dimmable element including a layer of one or more photochromic materials and a second dimmable element optically coupled with the first dimmable element to receive light transmitted through the first dimmable element. The first dimmable element is positioned away from one or more eyes of a wearer relative to the second dimmable element.

In accordance with some embodiments, a method for making an optical device includes placing a first dimmable element including a layer of one or more photochromic materials and a second dimmable element adjacent to the first dimmable element so that the second dimmable element is optically coupled with the first dimmable element to receive light transmitted through the first dimmable element.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 illustrates a user of an augmented reality headset (e.g., smart glasses), according to some embodiments.

FIGS. 2A-2E illustrate shutters for augmented reality headsets including a guest-host liquid crystal (GHLC) layer, a photochromic layer, and a combination thereof, according to some embodiments.

FIGS. 3A-3D illustrate a detailed cross-sectional view of a combined shutter under different configurations, according to some embodiments.

FIGS. 4A-4B illustrate the performance and cross section of a pixelated shutter, according to some embodiments.

FIGS. 5A-5B illustrate the performance of a combined shutter under different conditions, according to some embodiments.

FIG. 6 illustrates a thermal response of combined shutters, according to some embodiments.

FIG. 7 is a flowchart illustrating steps in a method for dimming the eyepieces of an augmented reality headset, according to some embodiments.

FIG. 8 is a block diagram illustrating an exemplary computer system with which the devices of FIG. 1, and the method 700 can be implemented, according to some embodiments.

FIGS. 9A-9C illustrate an optical device in different states in accordance with some embodiments.

FIG. 10 illustrates components of an optical device in accordance with some embodiments.

FIGS. 11A and 11B illustrate optical devices with an array of dimmable elements in accordance with some embodiments.

FIGS. 12A and 12B illustrate optical devices with different placement of photochromic materials relative to a substrate in accordance with some embodiments.

These figures are not drawn to scale unless indicated otherwise.

### DETAILED DESCRIPTION

In augmented reality applications, a headset or smart glass typically handles a computer-generated (e.g., virtual) image, in combination with a see-through (e.g., real) image provided via optical components such as eyepieces and the like. Real images typically have a high variability in brightness, depending on environmental conditions (e.g., whether the user is indoors or outdoors, in a car, in a bright sunny day, or an overcast day, or at night), and therefore it becomes desirable to adjust the brightness of the real image to a high degree of accuracy to pair it up with the brightness of the virtual image. Given the mobility of augmented reality headsets and smart glasses, it is desirable that any electronic control be provided in a compact form factor and be highly efficient in power consumption.

Electroactive dimming devices, which change their transparencies based on electrical signals, can be fast and can operate indoors and outdoors, but typically have a low dynamic range with lower transmission in the clear state and lower opacity in the dark state. In addition, certain electroactive dimming devices require high power, which are less desirable for mobile applications.

The present disclosure describes an optical device with one or more photochromic materials and a separate dimmable element (e.g., an electroactive dimming device) optically coupled with the one or more photochromic materials. The combination of the photochromic materials with a separate dimmable element enables low power, fast, and high dynamic range transparency levels for headsets and smart glasses in augmented reality applications. Photochromic materials are known to increase light absorption (e.g., of visible light) upon exposure to ultraviolet (UV) radiation. Hereinafter, ultraviolet radiation will be understood as electromagnetic radiation having a wavelength that is less than about 400 nanometers (nm). More specifically, ultraviolet radiation as disclosed herein may include electromagnetic radiation having a wavelength between about 100 nm, or less, and about 400 nm. Accordingly, an eyepiece that includes a layer of photochromic material becomes opaque in the presence of UV radiation. This effect is desirable as it involves no electrical power consumption and the transparency range between a clear state and a dark state can be large (e.g., a high transparency in the clear state and a high opacity in the dark state). One caveat of photochromic materials is that they are temperature-sensitive, and may lack a desirable tint level for the environment. Furthermore, they are not operational indoors, or in a car (where the automobile windows may have UV reflecting coating, thereby insufficient UV light is provided inside the car). By combining the one or more photochromic materials and a separate dimmable element, optical devices disclosed herein can operate both indoors and outdoors, and can be fine-tuned based on the environment and augmented reality content. For example, optical devices combining guest-host liquid crystal active layers with photochromic materials have a more stable performance over a wide range of temperatures, and offer greater homogeneity across the eyepiece in the presence of a temperature gradient.

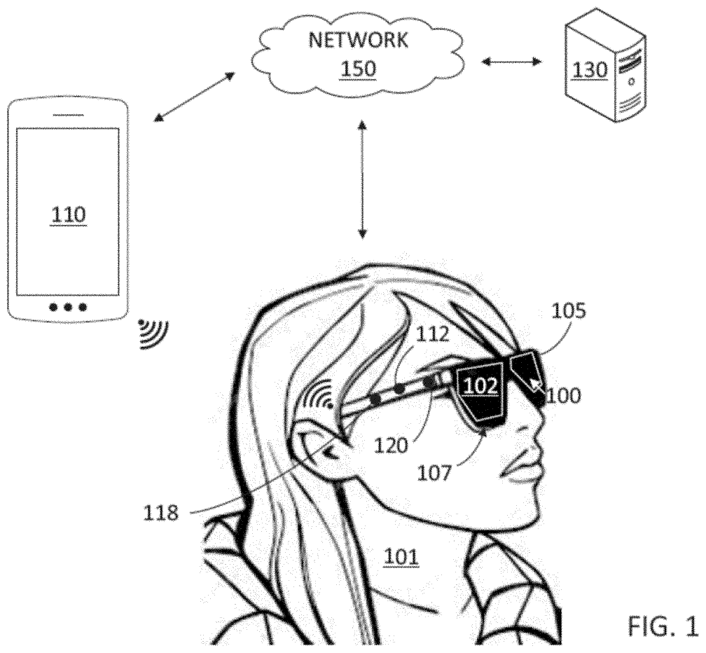

FIG. 1 illustrates a user 101 of an augmented reality headset 105 (e.g., smart glasses), according to some embodiments. Headset 105 may be communicatively coupled with a mobile device 110 (e.g., a smart phone, palm device, laptop, and the like) for the user, via an electromagnetic (EM) signal (e.g., radiofrequency signal, Wi-Fi, Bluetooth, and the like), and to a remote server 130 via a network 150 through a communications module 118. Headset 105 may also include a memory 120 storing instructions, and one or more processors 112 to execute the instructions and perform, at least partially, one or more steps as in methods as disclosed herein.

Headset 105 may include a display 102 configured to provide a virtual image to user 101. The virtual image may be generated by processor 112, or may be provided by mobile device 110 or server 130. The virtual image is superimposed to a see-through image in at least one of eyepieces 107. To control the visibility of the virtual image and the see-through image, eyepieces 100 in headset 105 have a shutter 100 to dim the transparency level of the headset based on ambient light conditions and certain configurations of the display. In some configurations, it may be desirable to dim the see-through image so as to enhance the visibility of the virtual image. In some configurations, it may be desirable to make the see-through image as clear as possible.

In yet some other embodiments, headset 105 may not include display 102, or it may be turned off. However, user 101 may desire to adjust the brightness of the see-through image with shutter 100.

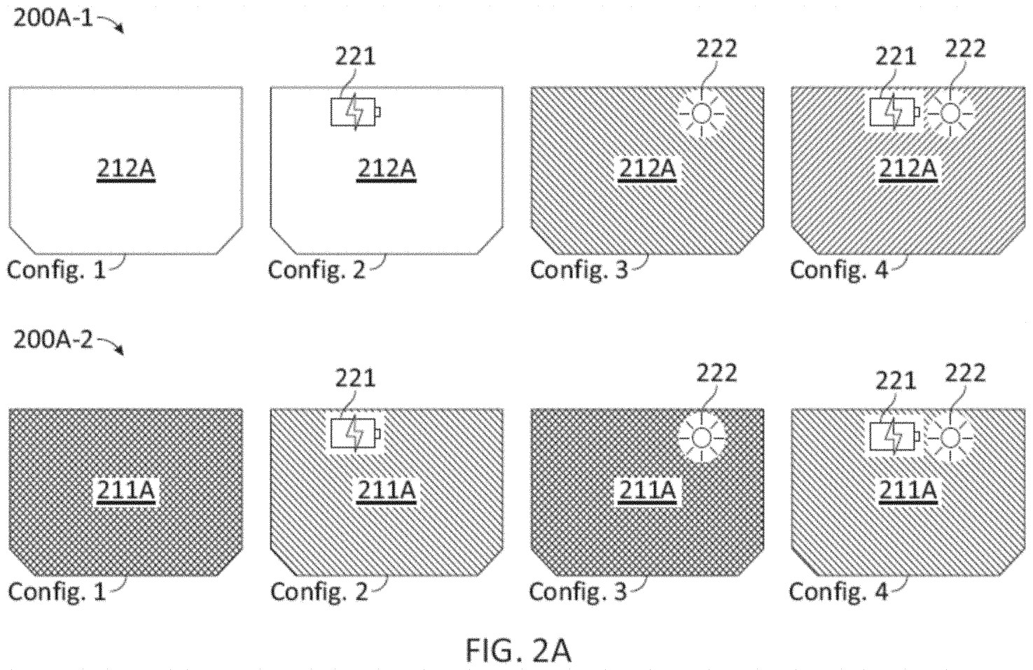

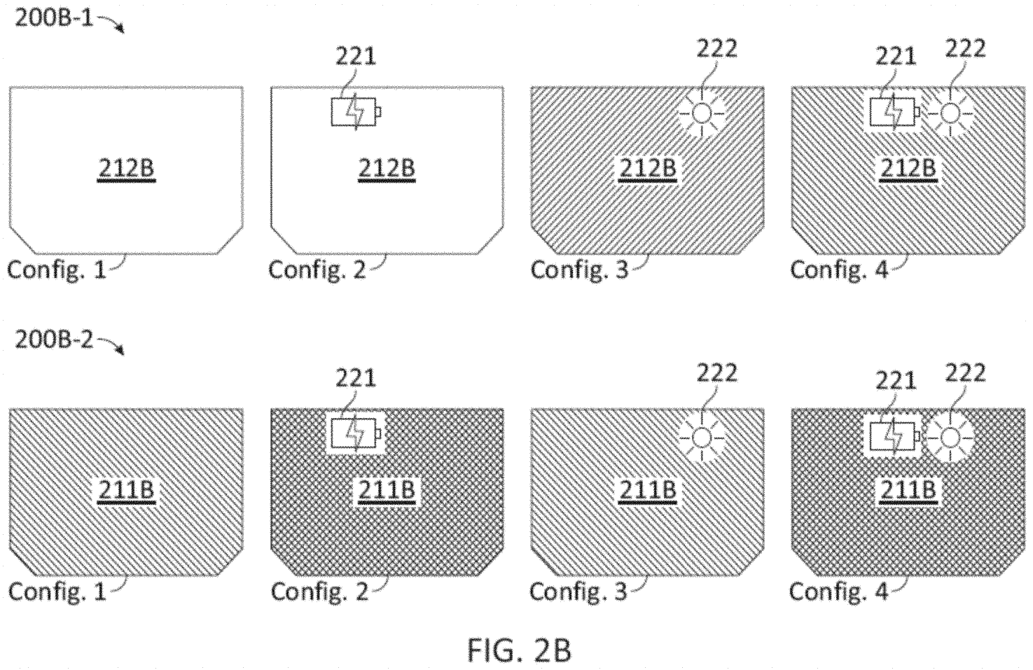

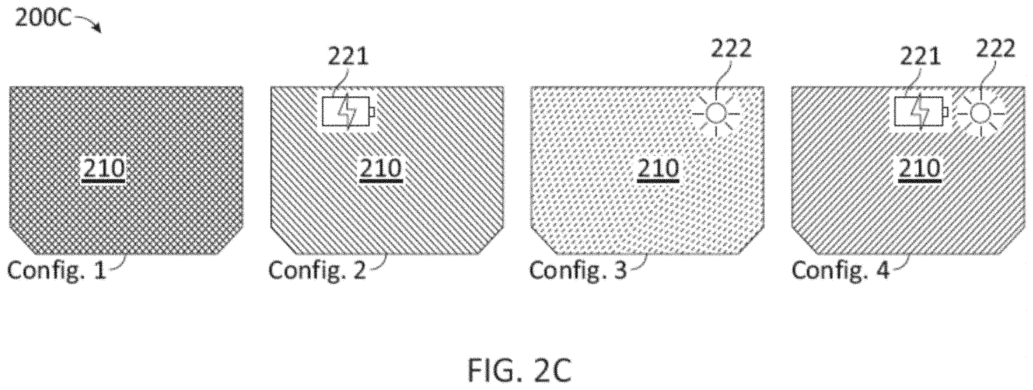

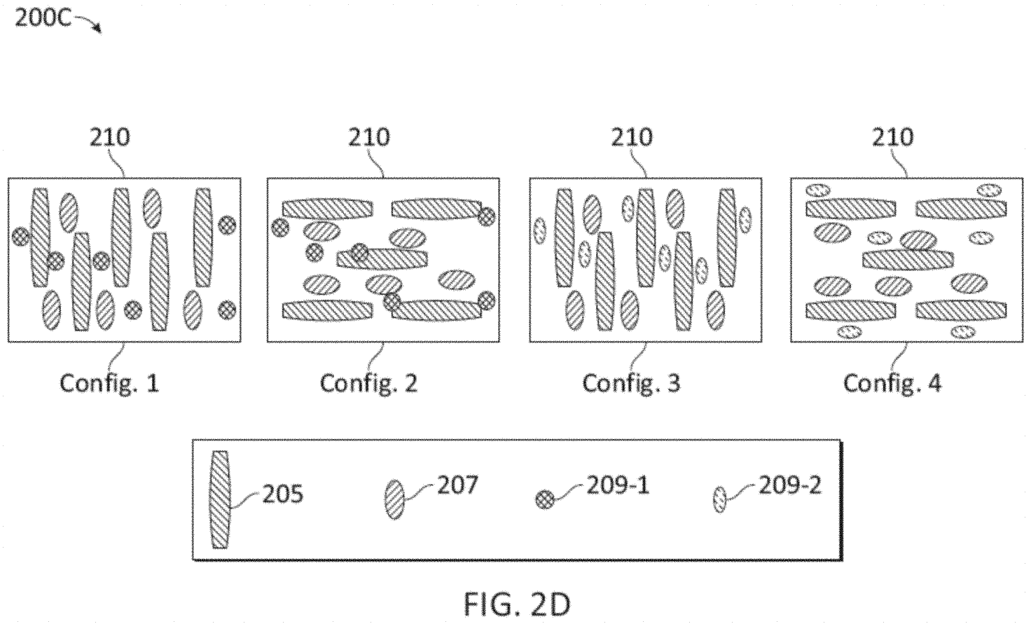

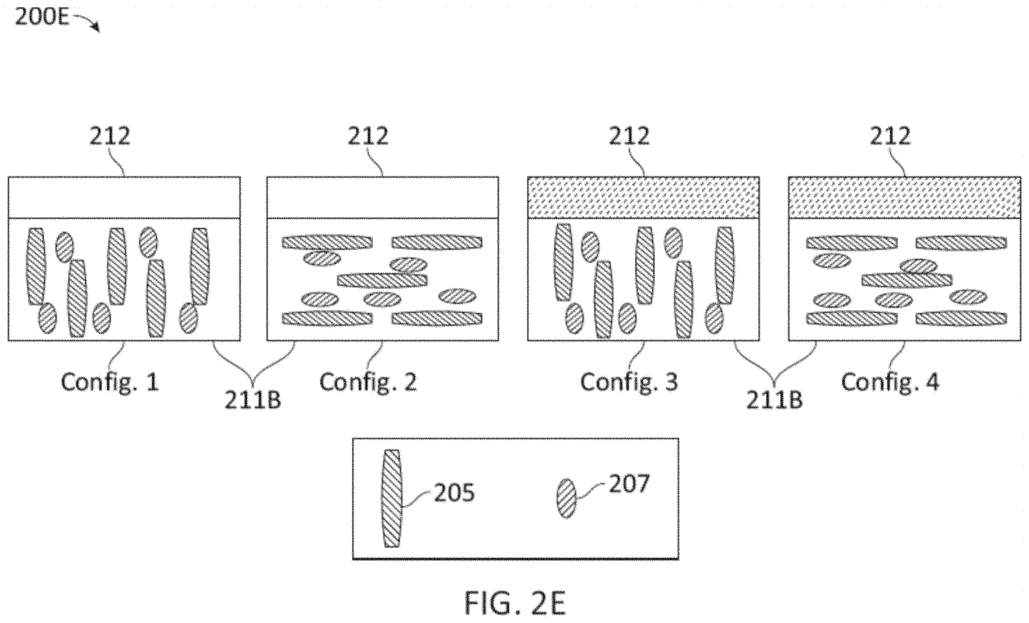

FIGS. 2A-2E illustrate shutters 200A-1, 200A-2, 200B-1, 200B-2, 200C, and 200E (hereinafter, collectively referred to as “shutters 200A, 200B, 200C and 200”) for augmented reality headsets including photochromic layers 212A and 212B (hereinafter, collectively referred to as “photochromic layers 212”), GHLC layers 211A and 211B (hereinafter, collectively referred to as “GHLC layers 211”), and a combination thereof (combination layer 210), according to some embodiments. The panels show different configurations, namely: a power 221 OFF, no UV 222 (“config. 1”); power 221 ON, no UV 222 (“config. 2”); power 221 OFF, UV 222 (“config. 3”); and power 221 ON with UV 222 (“config. 4”), with progressively increasing opacity.

FIGS. 2A-2B illustrate the performance of GHLC layers 211 and photochromic layers 212 separately, under the above four conditions. A default state under config. 1 for photochromic layer 212A in shutter 200A-1 and GHLC layer 211A in shutter 200A-2, is “clear.” A default state under config. 1 of photochromic layer 212B is “clear.” And a default state under no electrical power 221 of GHLC layer 211B is “dark” and under electrical power 221 is “clear.” Note that in the absence of UV radiation 222, photochromic layers 212 are clear even at no power 221 because the photochromic molecules have not changed their form factor (no UV absorption) and are therefore transparent to light.

FIGS. 2C and 2D show a shutter 200C with combination layer 210 in a normally clear state (e.g., in config. 1), according to some embodiments. In some embodiments, it is desirable to place GH molecules 205, LC molecules 207, and photochromic molecules (inactive 209-1, activated 209-2, and collectively referred to as “photochromic molecules 209”) in combination layer 210. This creates a synergistic effect wherein activated photochromic molecules 209-2 re-orient themselves along GH molecules 205 when power 221 is ON. This enhances the darkening effect of photochromic molecules 209, which are normally unresponsive to power 221 when placed on a separate layer of their own.

FIG. 2D illustrates a cross-sectional view of shutter 200C, for each one of configurations 1, 2, 3, and 4 in the combined active layer 210. Shutter 200C achieves a transparency range from a dark state with about 8% light transmission (config. 4) to a clear state of about 90% light transmission (config. 1).

In some embodiments, shutter 200C exhibits a transition time from configuration 1 to configuration 2 that may take less than one hundred (100) milliseconds (ms) to reach approximately 50% light transmission. The reverse transition from configuration 2 to configuration 1 may take about the same time to reach a 90% transmission. A transition from configurations 1 or 2 to configurations 3 or 4 may follow a Logistic curve behavior, with about thirty (30) seconds to achieve about 30% light transmission. The reverse transition from configurations 3 or 4 to configurations 1 or 2 also follow a Logistic curve, and may take about three (3) minutes to achieve 90% transmission. A transition from configuration 1 to configuration 4 may take about 100 ms to reach 50% light transmission and about thirty (30) seconds to reach about 8% transmission. The reverse transition from configuration 4 to configuration 1 may take about one hundred (100) ms to reach 30% light transmission, and about three (3) minutes to reach 90% light transmission.

FIG. 2E illustrates a layered shutter 200E that combines a GHLC layer 211B adjacent to photochromic layer 212, according to some embodiments. GHLC layer 211B includes GH molecules 205 and LC molecules 207. With no power and no UV (config. 1), GHLC layer 211B and photochromic layer 212 present a clear substrate and shutter 200E has maximum transparency. With power ON, but no UV (config. 2), GHLC layer 211B-2 presents a darker substrate, combined with a clear photochromic layer 212-1. With power OFF, in the presence of UV (config. 3), GHLC layer 211B-1 is clear, but photochromic layer 212-2 is dark. With power ON and in the presence of UV radiation (config. 4), GHLC layer 211B-2 is dark and so is photochromic layer 212-2. Accordingly, the different combination of power/UV factors results in a progressively increasing opacity of layered shutter 200E. In a clear state, layered shutter 200E has a light transmission of about 90%. When fully ‘on’ (power ON in the presence of UV radiation), layered shutter 200E achieves a dark state with about 11% transmission.

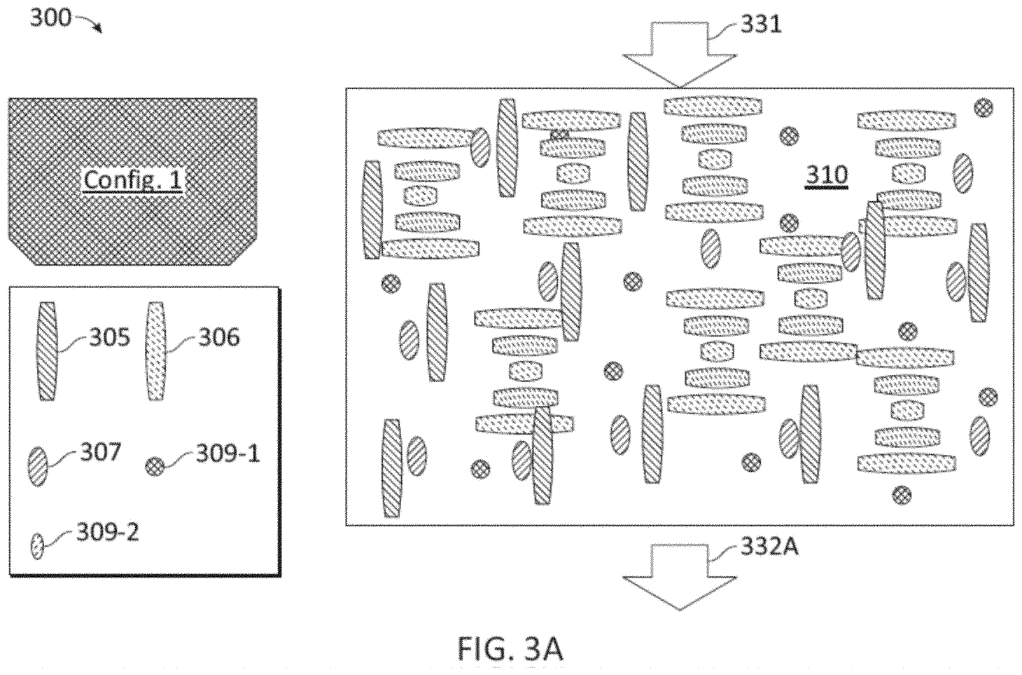

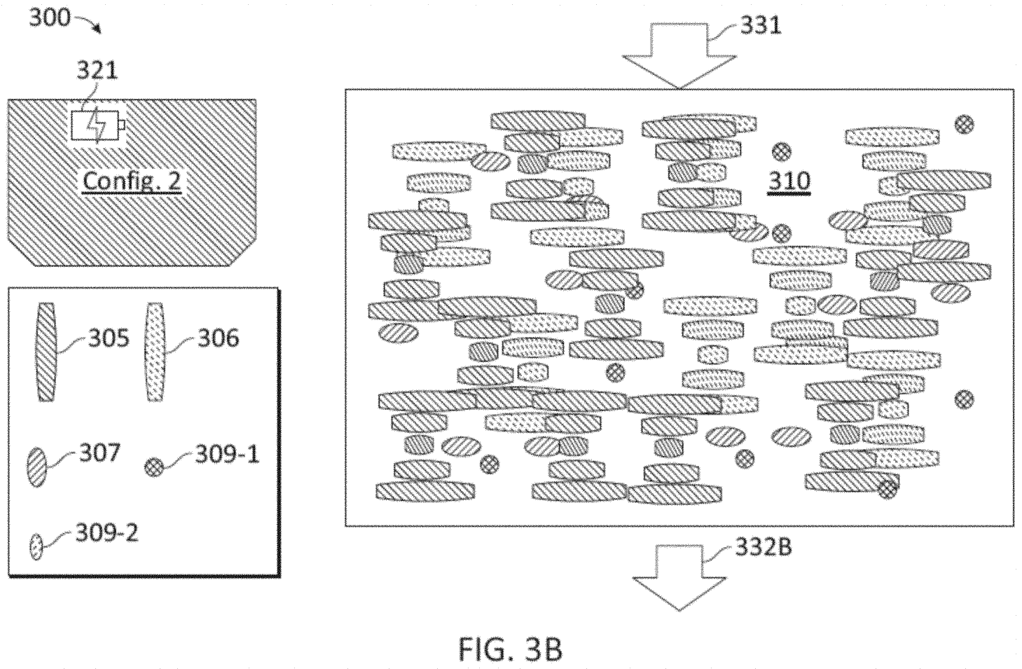

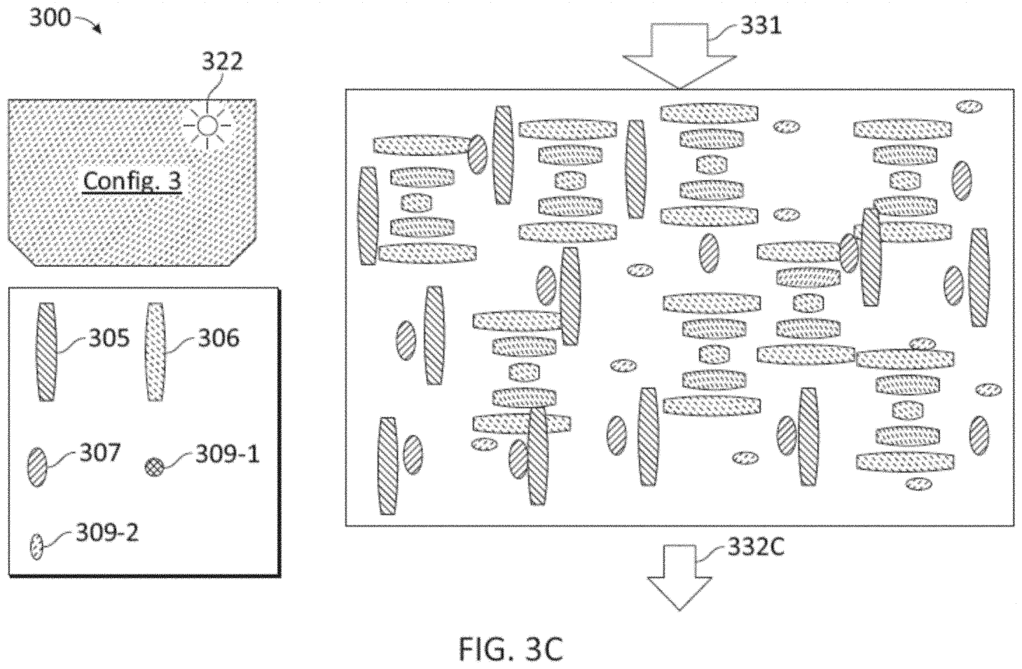

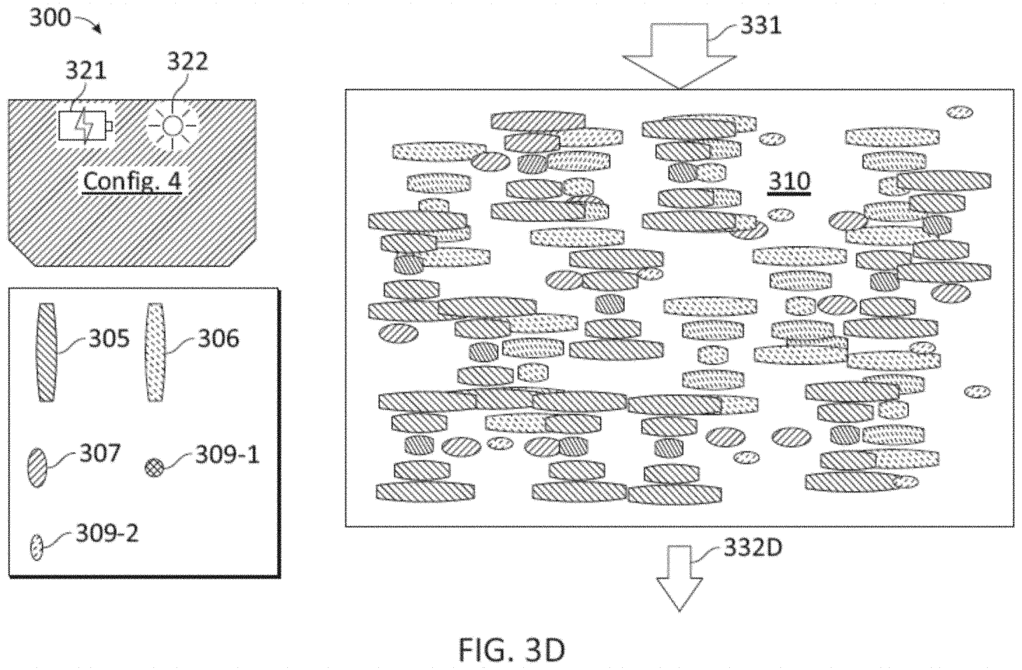

FIGS. 3A-3D illustrate detailed cross-sectional views of a combination layer 310 of combined shutter 300 under configurations 1, 2, 3, and 4, according to some embodiments. Configuration 1 includes a power OFF, and no UV radiation present on combination layer 310. Configuration 2 includes a power 321 ON, no UV radiation present in combination layer 310. Configuration 3 includes power OFF in the presence of UV radiation 322. And configuration 4 includes power 321 ON in the presence of UV radiation 322. Combination layer 310 includes GH molecules 305, polymerized LC molecules 306, a dichroic dye 307, inactive photochromic molecules 309-1, and activated photochromic molecules 309-2 (hereinafter, collectively referred to as “photochromic molecules 309”). Combined shutter 300 shows a progressively increasing opacity from configuration 1 through 4, as follows. An input light 331 goes through combination layer 310 and under the different configurations results in a varying intensity of throughput light 332A, 332B, 332C, and 332D (hereinafter, collectively referred to as “throughput light 332”).

In some embodiments, polymerized LC molecules 306 reduce the response time (e.g., increase the speed) of dichroic dye 307 (e.g., when power 321 is ON) and also of activated photochromic molecules 309-2 (e.g., in the presence of UV radiation 322) to align in a direction perpendicular to input light 331 (e.g., to reduce throughput light 332).

FIG. 3A illustrates the effect of configuration 1 on the transparency level of combination layer 310. In the absence of power, GH molecules 305 and dichroic dye 307 are aligned along the direction of input light 331. In the absence of UV radiation, photochromic molecules retain a small cross section. Accordingly, a small amount of input light 331 is absorbed, scattered, or blocked and throughput light 332A is similar in intensity to input light 331, resulting in a high transparency level.

FIG. 3B illustrates the effect of configuration 2 on the transparency level of combination layer 310. In the presence of power 321, GH molecules 305 and dichroic dye 307 are aligned perpendicularly to the direction of input light 331. Accordingly, a larger amount of input light 331 is absorbed, scattered, or blocked by dichroic dye 307, compared to configuration 1. Thus, throughput light 332B has a lower intensity than input light 331, resulting in a lower transparency level, compared to configuration 1. In the absence of UV radiation, photochromic molecules retain a small cross section and have little to no effect on the transparency level of configuration 2.

FIG. 3C illustrates the effect of configuration 3 on the transparency level of combination layer 310. In the absence of power, GH molecules 305 and dichroic dye 307 are aligned along the direction of input light 331. In the presence of UV radiation 322, activated photochromic molecules 309-2 swell to a large cross section, and are aligned perpendicularly to input light 331 by polymerized LC molecules 306. Accordingly, an amount of input light 331 is absorbed, scattered, or blocked and throughput light 332A is lower in intensity than input light 331, resulting in a lower transparency level than configuration 1 or 2.

FIG. 3D illustrates the effect of configuration 4 on the transparency level of combination layer 310. With power 321 ON, GH molecules 305 and dichroic dye 307 are aligned perpendicularly to the direction of input light 331. In the presence of UV radiation 322, photochromic molecules 309 become activated photochromic molecules 309-2. Polymerized LC molecules 306 force activated photochromic molecules 309-2 to align perpendicularly to the direction of input light 331, as well. Accordingly, a large amount of input light 331 is absorbed, scattered, or blocked by dichroic dye 307 and activated photochromic molecules 309-2. Throughput light 332D has the lowest intensity of all configurations, resulting in a low transparency level.

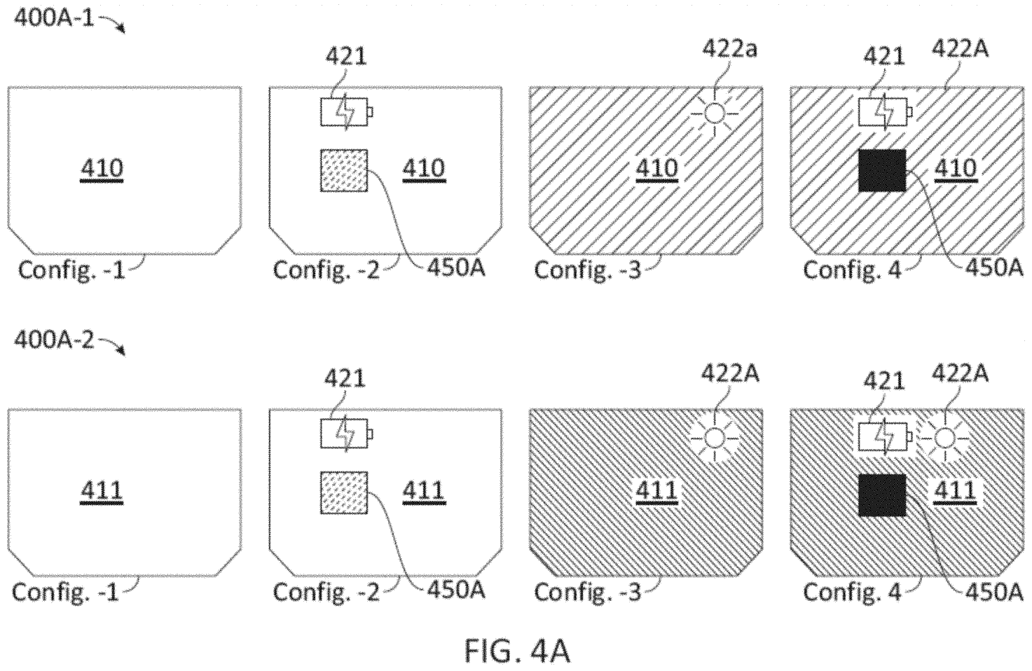

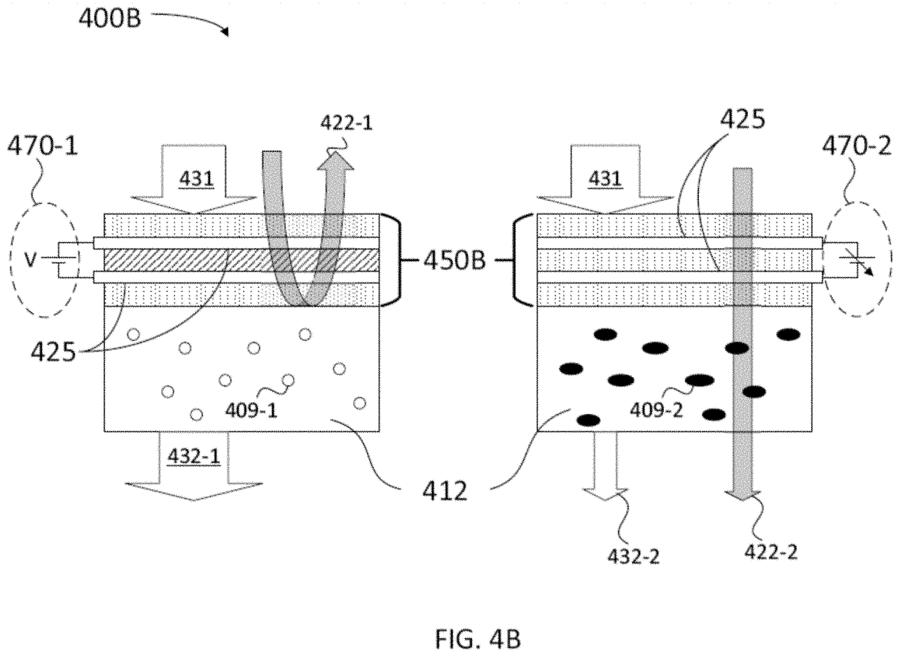

FIGS. 4A-4B illustrate the performance and cross section of pixelated shutters 400A-1, 400A-2, and 400B (hereinafter, collectively referred to as “pixelated shutters 400A,” and “400”), according to some embodiments. In a first embodiment, pixelated shutter 400-1 may include a combined layer 410 of GHLC molecules and photochromic molecules. In a second embodiment, pixelated shutter 400 may be a conjoined layer 411 including a first layer of photochromic molecules and a second layer of GHLC molecules. Pixelated shutters 400A may operate in configuration 1 with no power and the absence of UV radiation. A configuration 2 includes power 421 in the absence of UV radiation. A configuration 3 includes no power in the presence of UV radiation 422A, 422-1 and 422-2 (hereinafter, collectively referred to as “UV radiation 422”). And configuration 4 includes power 421 and the presence of UV radiation 422, with progressively increasing opacity. Pixelated shutters 400 can have a transparency adjustable layer divided into separately addressable pixels 450A. Accordingly, the transparency of selected portions in the eyepiece can be switched independently of the rest.

In some embodiments, combined layer 410 shows some darkening over the entire shutter in the presence of UV radiation 422, with switched pixels 450 darkening even further. Conjoined layer 411 would darken more than combined layer 410 in the presence of UV radiation 422, with switched pixels 450A darkening further, but not by as much as in the combined shutter design. The operation of switched pixels 450A on GHLC layers is a direct implementation of the power ON/OFF mechanism for these materials by appropriate segmentation of the electrodes used to provide power.

To have an improved pixelated effect on a photochromic layer 412, a pixelated shutter 400B includes a Bragg reflector 450B that is switchable. Bragg layer 450B may include multiple layers of LC molecules sandwiched between electrodes 425. The LC layers in Bragg reflector 450B have a thickness tuned to be operative in the UV wavelength range (e.g., about 190 nm to 400 nm), while substantially transparent in the visible wavelength range (e.g., about 450-750 nm). When a voltage 470-1 is provided between electrodes 425, a generated electric field alters the effective index of refraction of at least some alternating layers of LC molecules effectively converting Bragg reflector 450B into a mirror that prevents UV light 422-1 from reaching photochromic layer 412. Accordingly, with voltage 470-1, photochromic molecules 409-1 remain inactive and a throughput light 432-1 has substantially the same intensity as an input light 431. Thus, voltage 470-1 prevents photochromic layer 412 from obscuring a selected portion of pixelated shutter 400B, even in the presence of UV radiation 422. When a voltage 470-2 is reduced to zero, then Bragg reflector 450B is turned OFF, and becomes transparent to UV radiation 422-2, generating active photochromic molecules 409-2. Thus, a throughput light 432-2 may have a lower intensity than input light 431.

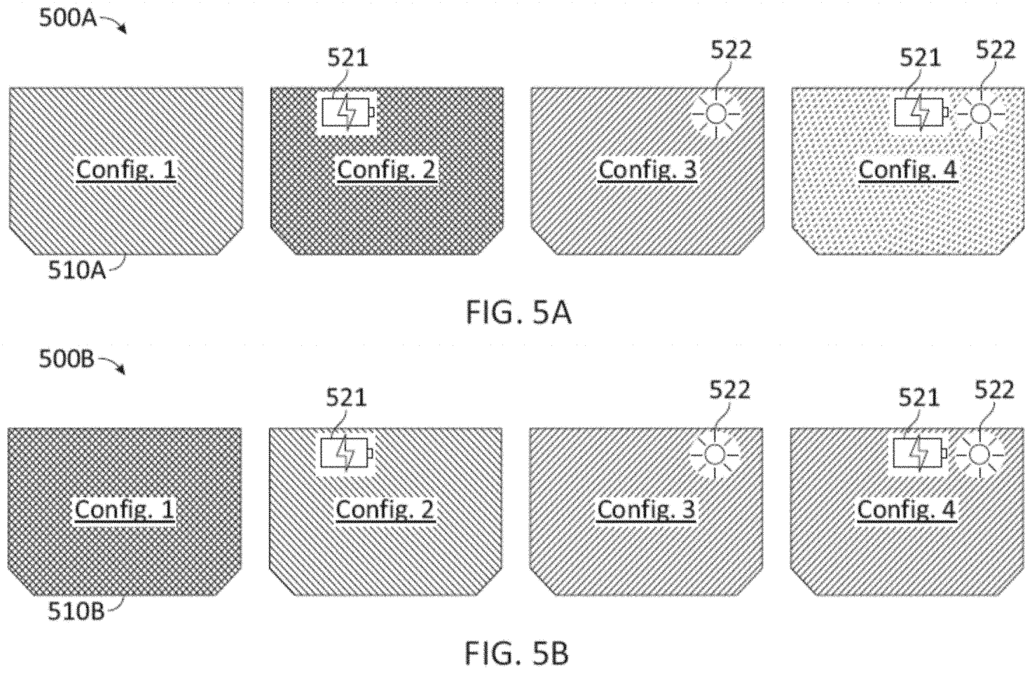

FIGS. 5A and 5B illustrate the performance of combined shutters 500A and 500B (hereinafter, collectively referred to as “combined shutters 500”) under different configurations, according to some embodiments. The four configurations are as described elsewhere: Configuration 1: power OFF and absence of UV radiation. Configuration 2: power 521 ON and absence of UV radiation. Configuration 3: no power in the presence of UV radiation 522. And configuration 4, power 521 ON in the presence of UV radiation 522. The varying transparency levels are different between combined shutters 500 according to the different state of a “no electrical power” response of photochromic molecules and GHLC molecules in combined layers 510A and 510B, respectively.

Combined layer 510A includes both photochromic molecules and GHLC layers activated and dark under no electrical power and in the presence of UV radiation 521. To achieve this, some embodiments may include GH molecules oriented perpendicularly to the direction of an input light as default. Accordingly, in configuration 1, a transmission of about 50% may be used indoors for augmented reality content enhancement. In configuration 2, a better transmission is achieved (about 90%), which can be desirable in many indoor applications of augmented reality (LC molecules shift parallel to the direction of input light). A dark state with about 8% transmission can be achieved in configuration 3 (e.g., the photochromic molecules, when absorbing UV radiation, are oriented perpendicularly to input light per GH molecules, thus adding to the opacity of the combined layer). In configuration 4, GH molecules shift orientation parallel to the input light, increasing transparency up to about 30%, which may be desirable for moderate outdoor situations, or for returning indoors from a bright outdoors.

Combined layer 510B includes photochromic molecules activated and dark in the presence of UV radiation, and GHLC molecules configured to align with the input light (clear) with no electrical power. Accordingly, in configuration 1, a transmission of about 90% may be used in many indoor situations. In configuration 2, a transmission of about 50% can be used in some indoor applications of AR. A dark state with about 15% transmission can be achieved in configuration 3. Accordingly, the photochromic molecules absorb UV radiation and are oriented perpendicularly to the direction of incoming light, thus adding to the opacity of the combined layer. Configuration 3 may be desirable for outdoor use of augmented reality headsets and smart glasses. In configuration 4, a similar transmission of about 15% is maintained (but in some embodiments with a better temperature stability and faster transition to a clear state).

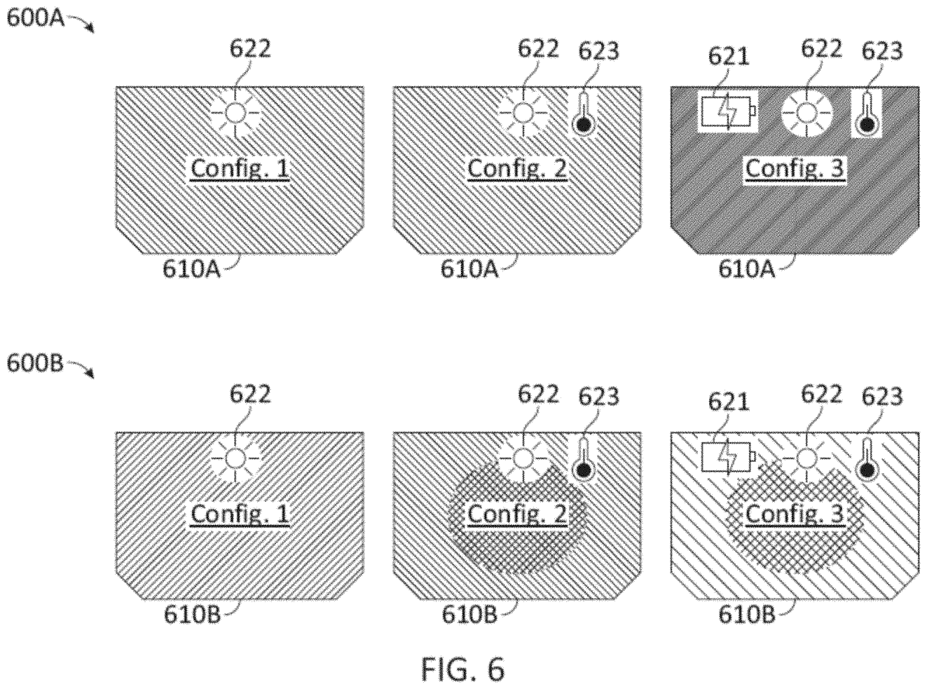

FIG. 6 illustrates a thermal response of combined shutter 600A and layered shutter 600B (hereinafter, collectively referred to as “shutters 600”), according to some embodiments. Shutters 600 may face different configurations of factors (or operation conditions) in active layers 610A and 610B (hereinafter, collectively referred to as “active layers 610”). Configuration 1 includes the presence of UV radiation 622 at room temperature (e.g., 25° C. or lower). Configuration 2 includes an increased temperature 623 in the presence of UV radiation 622. And configuration 3 includes a power 621 ON, in addition to increased temperature 623, in the presence of UV radiation 622.

In some embodiments, combined shutter 600A (at T˜5° C.), with power 621 ON and in the presence of UV radiation 622, may take about sixty (60) seconds to darken to about 12% light transmission, and about twenty (20) minutes to reach a clear state after shutting down the power, in the absence of UV radiation 622. At 23° C., it takes about thirty (30) seconds to darken to a 30% or an 8% transmission, and about three (3) minutes to reach a clear state with no power and no UV radiation. And at 35° C., it takes about twenty (20) seconds to darken to a 16% transmission, and about one and a half (1.5) minutes to reach a clear state with no power and no UV.

In some embodiments, the timing performance of a layered shutter as disclosed herein may be as follows. A transition time between power 621 OFF to power 621 ON may take less than one hundred (100) milliseconds (ms) to reach approximately 50% light transmission. The reverse transition (e.g., from power 621 ON to power 621 OFF) takes about the same time to reach a 90% transmission. A transition between absence and presence of UV radiation 622 follows a Logistic curve behavior, with about thirty (30) seconds to achieve about 20% light transmission. The reverse transition between presence and absence of UV radiation 622 also follows a Logistic curve and may take about three (3) minutes to achieve 90% transmission. A transition between power 621 OFF with no UV radiation 622 and power 621 ON in the presence of UV radiation 622 may take about 100 ms to reach 50% light transmission and about thirty (30) seconds to reach about 11% transmission. A transition between power 621 ON, in the presence of UV radiation 622, and a power 621 OFF, in the absence of UV radiation 622, may take about one hundred (100) ms to reach 20% light transmission, and about three (3) minutes to reach 90% light transmission.

The temperature performance of layered shutter 600B may be as follows. At 5° C., it takes about sixty (60) seconds to darken to a 9% light transmission, and about thirty (30) minutes to reach a clear state with no power 621, in the absence of UV radiation 622. At 23° C. it takes about thirty (30) seconds to darken to a 20% or 11% transmission, and about five (5) minutes to reach a clear state with no power 621 in the absence of UV radiation 622. At T˜35° C., it takes about twenty (20) seconds to darken to a 22% transmission, and about two (2) minutes to reach a clear state with no power 621 in the absence of UV radiation 622.

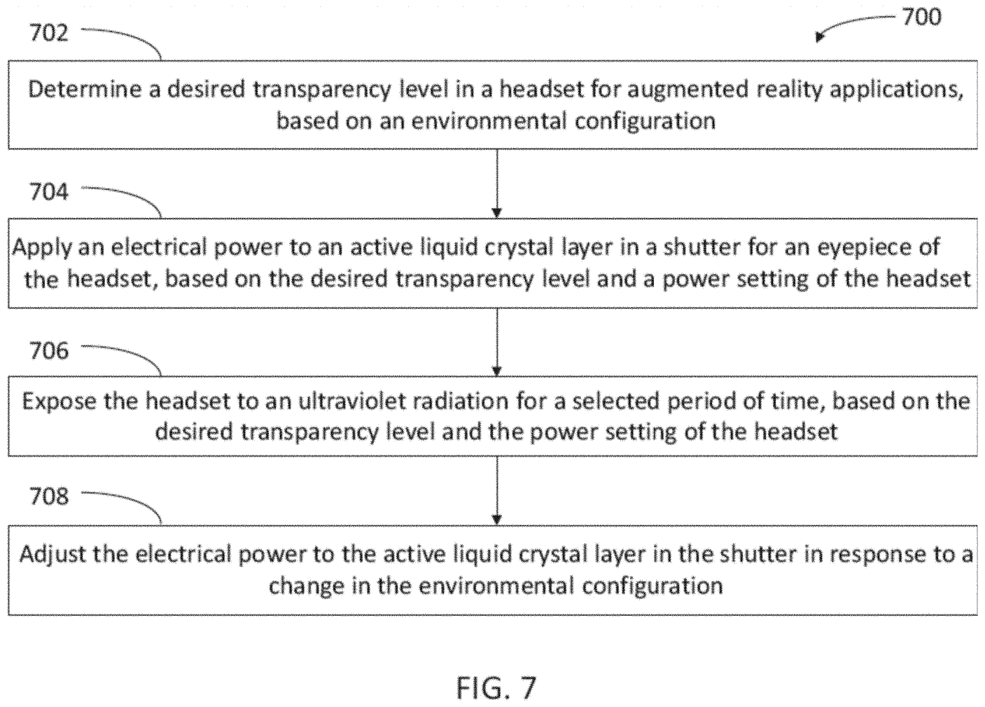

FIG. 7 is a flowchart illustrating steps in a method 700 for dimming the eyepieces of an augmented reality headset, according to some embodiments. Accordingly, at least one or more of the steps in method 700 may be performed by a processor circuit executing instructions stored in a memory circuit within an enhanced reality device, headset, or smart glass, a computer, a mobile device, or a remote server, as disclosed herein (cf. processor 112, memory 120, headset 105, mobile device 110, and server 130). In some embodiments, at least some of the steps in method 700 may be performed by the mobile device or remote server wirelessly communicating with the enhanced reality device, headset, or smart glass using a communications module, directly or via a network (cf. communications module 118, network 150). Moreover, methods consistent with the present disclosure may include at least one or more of the steps in method 700 performed in a different order, simultaneously, quasi-simultaneously, or overlapping in time.

Step 702 includes determining a desired transparency level in a headset for augmented reality applications, based on an environmental configuration. In some embodiments, step 702 includes determining whether the headset is outdoors or indoors. In some embodiments, step 702 includes identifying a user gesture indicative of a desire to adjust a transparency level in the headset. In some embodiments, step 702 includes determining an amount of ultraviolet radiation present in the environmental configuration, and determining an amount of electrical power needed to achieve the desired transparency level based on a photochromic response of the shutter to the amount of ultraviolet radiation present.

Step 704 includes applying an electrical power to an active liquid crystal layer in a shutter for an eyepiece of the headset, based on the desired transparency level and a power setting of the headset. In some embodiments, the power setting of the headset indicates a fully charged battery, and step 704 includes applying an amount of electrical power above a threshold to adjust a transparency of the eyepiece to the desired transparency level within the selected period of time.

Step 706 includes exposing the headset to an ultraviolet radiation for a selected period of time, based on the desired transparency level and the power setting of the headset.

Step 708 includes adjusting the electrical power to the active liquid crystal layer in the shutter in response to a change in the environmental configuration. In some embodiments, step 708 includes determining the selected period of time based on an amount of ultraviolet radiation present, a temperature of the environmental configuration, and the power setting of the headset.

Some embodiments may include vibrating actuators disposed in close proximity to the skull, in a headset, taking advantage of acoustic propagation through bone to reach the audition neural network in the brain. Accordingly, users who have limited hearing may enjoy the audio of a media download.

### Hardware Overview

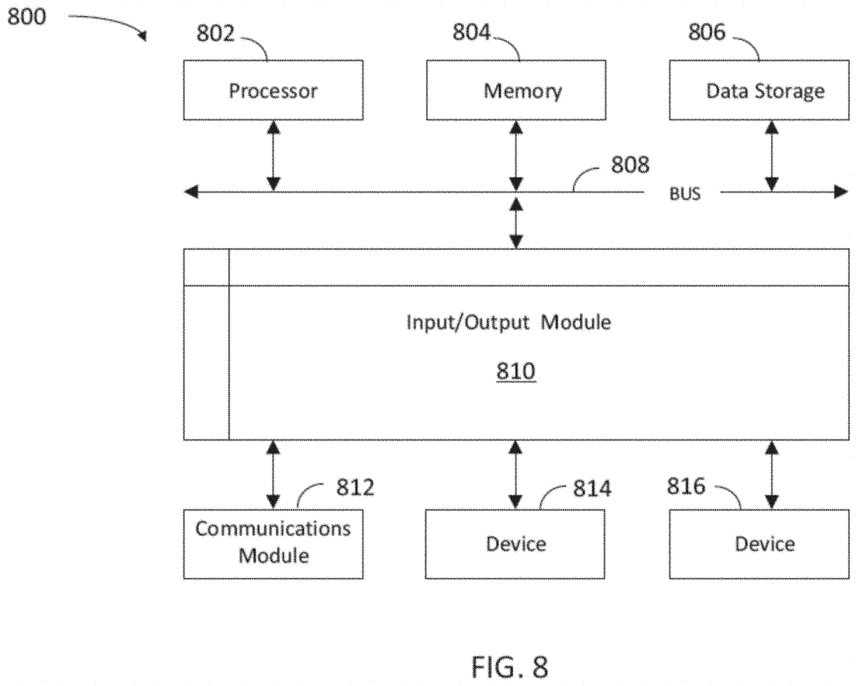

FIG. 8 is a block diagram illustrating an exemplary computer system 800 with which the headset 105 of FIG. 1, and method 700 can be implemented, according to some embodiments. In certain aspects, computer system 800 may be implemented using hardware or a combination of software and hardware, either in a dedicated server, or integrated into another entity, or distributed across multiple entities. Computer system 800 may include a desktop computer, a laptop computer, a tablet, a phablet, a smartphone, a feature phone, a server computer, or otherwise. A server computer may be located remotely in a data center or be stored locally.

Computer system 800 includes a bus 808 or other communication mechanism for communicating information, and a processor 802 (e.g., processor 112) coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, code that creates an execution environment for the computer program in question, e.g., code that constitutes processor firmware, a protocol stack, a database management system, an operating system, or a combination of one or more of them stored in an included memory 804 (e.g., memory 120), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 808 for storing information and instructions to be executed by processor 802. The processor 802 and the memory 804 can be supplemented by, or incorporated in, special purpose logic circuitry.

The instructions may be stored in the memory 804 and implemented in one or more computer program products, e.g., one or more modules of computer program instructions encoded on a computer-readable medium for execution by, or to control the operation of, the computer system 800, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled with bus 808 for storing information and instructions. Computer system 800 may be coupled via input/output module 810 to various devices. Input/output module 810 can be any input/output module. Exemplary input/output modules 810 include data ports such as USB ports. The input/output module 810 is configured to connect to a communications module 812. Exemplary communications modules 812 include networking interface cards, such as Ethernet cards and modems. In certain aspects, input/output module 810 is configured to connect to a plurality of devices, such as an input device 814 and/or an output device 816. Exemplary input devices 814 include a keyboard and a pointing device, e.g., a mouse or a trackball, by which a consumer can provide input to the computer system 800. Other kinds of input devices 814 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 816 include display devices, such as an LCD (liquid crystal display) monitor, for displaying information to the consumer.

According to one aspect of the present disclosure, augmented reality headset 105 can be implemented, at least partially, using a computer system 800 in response to processor 802 executing one or more sequences of one or more instructions contained in memory 804. Such instructions may be read into memory 804 from another machine-readable medium, such as data storage device 806. Execution of the sequences of instructions contained in main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

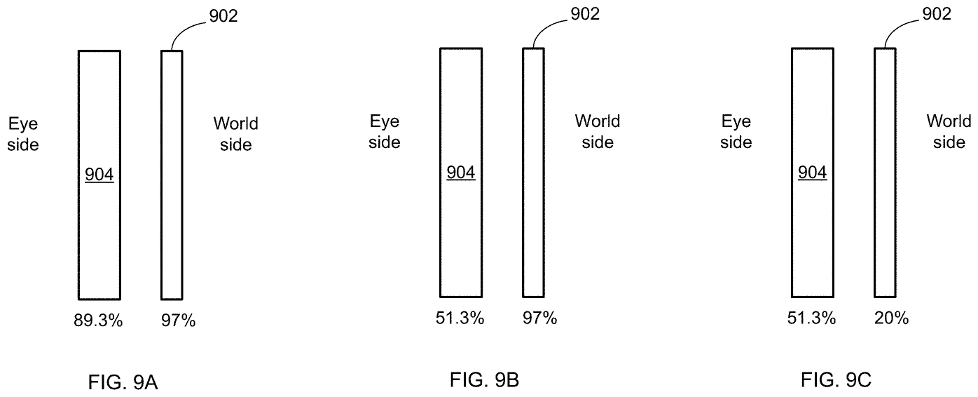

FIGS. 9A-9C illustrate an optical device in different states in accordance with some embodiments.

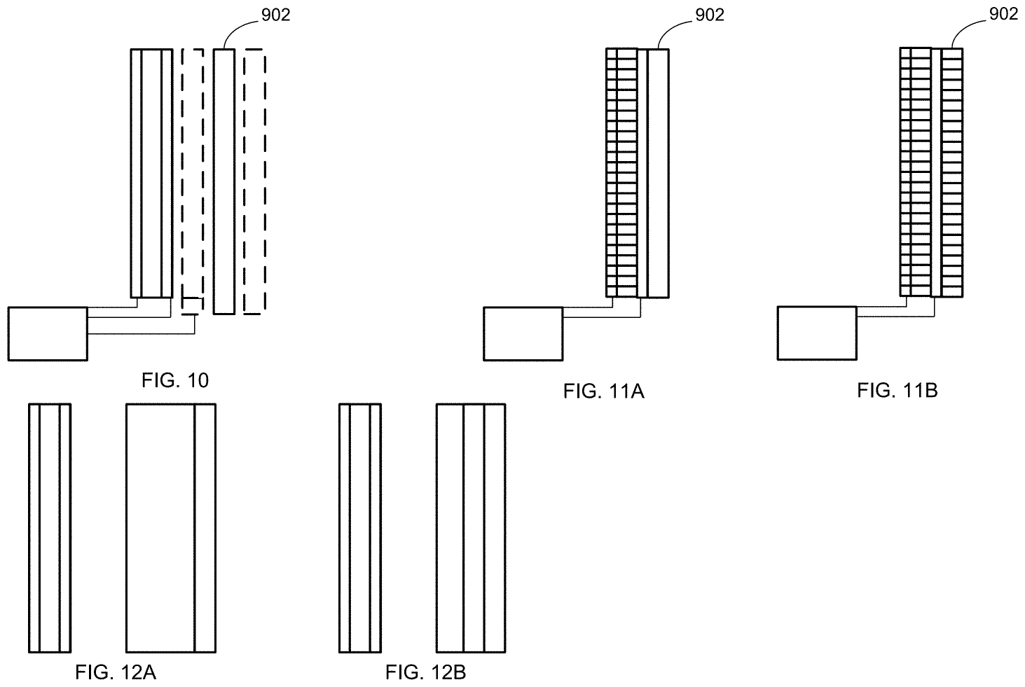

FIG. 10 illustrates components of an optical device in accordance with some embodiments.

FIGS. 11A and 11B illustrate optical devices with an array of dimmable elements in accordance with some embodiments.

FIGS. 12A and 12B illustrate optical devices with different placement of photochromic materials relative to a substrate in accordance with some embodiments.

In view of these examples, certain embodiments are described as follows:

In accordance with some embodiments, an optical device includes (i) a first dimmable element including a layer of one or more photochromic materials (e.g., photochromic layers 212A or 212B) and (ii) a second dimmable element (e.g., GHLC layers 211A or 211B) optically coupled with the first dimmable element to receive light transmitted through the first dimmable element.

In some embodiments, the first dimmable element has a first optical transparency while the first dimmable element is in a first state (e.g., 212A in Config. 1) and a second optical transparency that is distinct from the first optical transparency while the first dimmable element is in a second state that is distinct from the first state (e.g., 212A in Config. 4). The second dimmable element has a third optical transparency while the second dimmable element is in a third state (e.g., 211A in Config. 1) and a fourth optical transparency that is distinct from the third optical transparency while the second dimmable element is in a fourth state that is distinct from the third state (e.g., 211A in Config. 4).

In some embodiments, the optical device includes an electronic controller for placing the second dimmable element in the third state at a first time and in the fourth state at a second time that is distinct from the first time.

In some embodiments, the optical device includes an optical sensor positioned to determine an intensity of light transmitted through the first dimmable element, wherein the optical sensor is coupled with the electronic controller to provide information indicating the intensity of light transmitted through the first dimmable element.

In some embodiments, the first dimmable element transitions from the first state to the second state and from the second state to the first state independent of the electronic controller.

In some embodiments, a substrate with the layer of one or more photochromic materials.

In some embodiments, the substrate includes a non-planar surface on which the layer of one or more photochromic materials is located.

In some embodiments, the second dimmable element includes a guest host liquid crystal element.

In some embodiments, the guest host liquid crystal element includes liquid crystals and one or more selected from a group consisting of: polymers, inorganic particles, or dichroic dye.

In some embodiments, the second dimmable element also includes a second guest host liquid crystal element that is distinct from the first guest host liquid crystal element.

In some embodiments, the second dimmable element includes an electrophoretic display.

In some embodiments, the second dimmable element includes an electrochromic display.

In some embodiments, the electrochromic display includes one or more selected from the group consisting of: inorganic metal oxide, conductive polymer, viologen, or any combination thereof.

In some embodiments, the optical device includes a layer of an infrared filter optically coupled with the first dimmable element to reduce infrared light provided to the layer of one or more photochromic materials.

In some embodiments, the optical device includes an array of dimmable elements of a first type, a respective dimmable element of the array of dimmable elements of the first type corresponding to the first dimmable element; and an array of dimmable elements of a second type, a respective dimmable element of the array of dimmable elements of the second type corresponding to the second dimmable element.

In accordance with some embodiments, a head-mounted display includes any optical device described herein. The first dimmable element is positioned away from one or more eyes of a wearer relative to the second dimmable element.

In accordance with some embodiments, a method for making an optical device includes placing a first dimmable element including a layer of one or more photochromic materials and a second dimmable element adjacent to the first dimmable element so that the second dimmable element is optically coupled with the first dimmable element to receive light transmitted through the first dimmable element.

In some embodiments, the method also includes forming or applying the layer of one or more photochromic materials on a substrate.

In some embodiments, the method also includes molding a substrate in the presence of the one or more photochromic materials.

In some embodiments, the layer of one or more photochromic materials is located on a surface of the substrate.

In some embodiments, the layer of one or more photochromic materials is embedded in the substrate.

In some embodiments, the one or more photochromic materials are coupled with guest host liquid crystal materials prior to molding the substrate.

In some embodiments, the substrate includes a lens.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 800 can include clients and servers. A client and server are generally remote from each other and typically interact through a communication network. The relationship of client and server arises by virtue of computer programs running on the respective computers and having a client-server relationship to each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires forming bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

Embodiments described herein may include or be implemented in conjunction with an artificial reality system. Artificial reality is a form of reality that has been adjusted in some manner before presentation to a user, which may include, e.g., an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, and other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An optical device, comprising:
a first dimmable element including a layer of one or more photochromic materials; and
a second dimmable element optically coupled with the first dimmable element to receive light transmitted through the first dimmable element.

2. The optical device of claim 1, wherein:
the first dimmable element has a first optical transparency while the first dimmable element is in a first state and a second optical transparency that is distinct from the first optical transparency while the first dimmable element is in a second state that is distinct from the first state; and
the second dimmable element has a third optical transparency while the second dimmable element is in a third state and a fourth optical transparency that is distinct from the third optical transparency while the second dimmable element is in a fourth state that is distinct from the third state.

3. The optical device of claim 2, further comprising:
an electronic controller for placing the second dimmable element in the third state at a first time and in the fourth state at a second time that is distinct from the first time.

4. The optical device of claim 3, further comprising:
an optical sensor positioned to determine an intensity of light transmitted through the first dimmable element, wherein the optical sensor is coupled with the electronic controller to provide information indicating the intensity of light transmitted through the first dimmable element.

5. The optical device of claim 3, wherein:
the first dimmable element transitions from the first state to the second state and from the second state to the first state independent of the electronic controller.

6. The optical device of claim 1, including:
a substrate with the layer of one or more photochromic materials.

7. The optical device of claim 6, wherein:
the substrate includes a non-planar surface on which the layer of one or more photochromic materials is located.

8. The optical device of claim 1, wherein:
the second dimmable element includes a guest host liquid crystal element.

9. The optical device of claim 8, wherein:
the guest host liquid crystal element includes liquid crystals and one or more selected from a group consisting of: polymers, inorganic particles, or dichroic dye.

10. The optical device of claim 8, wherein:
the second dimmable element also includes a second guest host liquid crystal element that is distinct from the first guest host liquid crystal element.

11. The optical device of claim 1, wherein:
the second dimmable element includes an electrophoretic display.

12. The optical device of claim 1, wherein:
the second dimmable element includes an electrochromic display.

13. The optical device of claim 12, wherein:
the electrochromic display includes one or more selected from the group consisting of:
inorganic metal oxide, conductive polymer, viologen, or any combination thereof.

14. The optical device of claim 1, further comprising:
a layer of an infrared filter optically coupled with the first dimmable element to reduce infrared light provided to the layer of one or more photochromic materials.

15. The optical device of claim 1, including:
an array of dimmable elements of a first type, a respective dimmable element of the array of dimmable elements of the first type corresponding to the first dimmable element; and
an array of dimmable elements of a second type, a respective dimmable element of the array of dimmable elements of the second type corresponding to the second dimmable element.

16. A head-mounted display, comprising:
the optical device of claim 1, wherein the first dimmable element is positioned away from one or more eyes of a wearer relative to the second dimmable element.

17. A method for making an optical device, the method comprising:
placing a first dimmable element including a layer of one or more photochromic materials and a second dimmable element adjacent to the first dimmable element so that the second dimmable element is optically coupled with the first dimmable element to receive light transmitted through the first dimmable element.

18. The method of claim 17, further comprising:
forming or applying the layer of one or more photochromic materials on a substrate.

19. The method of claim 17, further comprising:
molding a substrate in the presence of the one or more photochromic materials.

20. The method of claim 19, wherein the one or more photochromic materials are coupled with guest host liquid crystal materials prior to molding the substrate.
